(19) United States
(12) Patent Application Publication
(10) Pub. No.: US 2002/0116296 A1
(43) Pub. Date: Aug. 22, 2002

(54) Electronic commercial transaction supporting method and system, and business information management system therefor

(76) Inventor: Tosiyasu L. Kunii, Tokyo (JP)

Correspondence Address: Dowell & Dowell, P.C., Suite 309, 1215 Jefferson Davis Highway, Arlington, VA, 22202, US

(21) Appl. No.: 09/991,953

(22) Filed: Nov. 26, 2001

Related U.S. Application Data
(60) Provisional application No. 60/252,589, filed on Nov. 24, 2000.

(30) Foreign Application Priority Data
Apr. 17, 2001 (JP) 2001-118930

(51) Int. Cl. G06F 17/60

(52) U.S. Cl. 705/27; 705/10

(57) ABSTRACT

The invention is an electronic commercial transaction supporting method and system using Cellular Information Model theory. A plurality of e-customers and e-shops or e-malls are connected to the Internet. A piece of merchandise has numerous attributes but an e-customer is only interested in a limited number of them in any given transaction. Moreover, the attributes described by an e-shop or e-mall do not necessarily coincide with those specified by the e-customer. Correspondence relations between the attributes of interest to the e-customer and the e-mall, respectively, are established based on the history of a transaction and recorded in an attribute correspondence relation table. A global business information management system monitors and maintains local attribute correspondence relation tables on a global level, so that useful correspondence relations established in one e-shop or e-mall are used in transactions in other e-shops or e-malls.

### CROSS REFERENCE TO RELATED APPLICATIONS

This application claims the benefit of U.S. Provisional Application No. 60/252,589, filed Nov. 24, 2000 the contents of which are hereby incorporated by reference.

### BACKGROUND OF THE INVENTION

1. Field of the Invention

The present invention relates to an electronic commercial transaction supporting technology and business information management technology, and more particularly, relates to a method, apparatus, system, database or the like for supporting electronic commerce or any business using a network.

2. Description of the Related Art

Cyberworlds are being formed on the web either intentionally or spontaneously, with or without design. Widespread and intensive local activities are melting into or fusing with each other on the web globally to create cyberworlds. What is commonly called e-business, including electronic financing, has been conducted in cyberworlds and may have crossed a national finance level in its scale.

Without proper modeling, cyberworlds will continue to grow chaotically and may soon be out of range for human control or understanding. A combination or unification of the existing spatial and temporal database models will not solve the problem because local activities interact and are interconnected with each other through the Internet and consequently it is generally not possible to treat any particular local activity as independent. Current relational models, which are based on a so-called “world model”, assume the presence of a manager who manages the interdependent relations among all the data or attributes in a uniform and centralized manner. These models may be useful when the relevant information is confined within a closed and independent space or environment, such as in a company, where it is possible to control the interdependent relations of data or attributes. However, such control is virtually impossible in cyberworlds, where interdependent relations between unrelated businesses around the globe operate simultaneously through networks such as the World Wide Web (“Web”). Therefore, it is difficult to adequately model activities on the Web using the “world model” concept such that useful information about these activities can be recorded in a database or the like for easy retrieval and reuse.

### SUMMARY OF THE INVENTION

The present invention has been made in view of the above problem and an object of the present invention is to provide a novel database or an information model that enables the reuse of multi-dimensional information in a complex system, such as the Web.

One embodiment of the present invention relates to an electronic commercial transaction supporting method. This method includes: extracting, by a cell operation of a technique of cellular information theory, correspondence relations between attributes determined by respective viewpoints of a plurality of subjects involved in an electronic commercial transaction; recording the extracted correspondence relations; and presenting the recorded correspondence relations at a stage of the electronic commercial transaction. These processes are realized in an electronic form via networks.

The “cellular information theory” is the basic theory for the information model provided herein, which results from expanding general cellular structure theory into a practical form.

As an illustrative example, the “subjects” (participants) may include “e-shops” that offer and sell commercial products or services online, “e-customers” that purchase products and services online, and others that participate in these online transactions. The “respective viewpoints” related to a group or set of attributes chosen by particular subjects from all the attributes related to a transaction. For example, from the e-customer's viewpoint an attribute such as price might be more important than other attributes. Although viewpoints are subjective, subjectivity will not pose a fundamental difficulty in the present invention because in accordance with cellular information theory, the correspondence relations among attributes continuously evolve through growth and self-correction, as will be seen in the following description of the preferred mode of the present invention.

Another embodiment of the present invention also relates to an electronic commercial transaction supporting method. This method includes: specifying correspondence relations between attributes determined by respective viewpoints of a plurality of subjects involved in an electronic commercial transaction based on a predetermined equivalence relation; extracting the specified correspondence relation by a cell operation based on cellular information theory; accumulating correspondence relations in a data table, based on actual examples of an electronic commercial transaction; and presenting the accumulated correspondence relations as a part of another electronic commercial transaction, by referring to the data table.

Another embodiment of the present invention again relates to an electronic commercial transaction supporting method. This method includes: extracting, based on a predetermined equivalence relation, an attribute that is an object of interest common to a plurality of subjects involved in an electronic commercial transaction using a method of cell decomposition in cellular information theory; and adding the extracted attribute to a cellular space corresponding to each of the plurality of subjects using a method of cell attachment.

Using the same illustrative example, one example of an “attribute that is an object of interest” may be the price of a product. An e-customer may specify a condition of purchase as at a price “less than 15000 yen”. Of course, the e-shop has to specify an offering price of the product, also less than 15000 yen, for the price to be a “common” attribute. There is then a predetermined equivalence relation in that the prices specified by the e-customer and the e-shop are both “less than 15000 yen” and a product priced at “less than 15000 yen” would satisfy the equivalence, symmetric and transitive rules or laws hereinafter described. By setting this equivalence relation, one can use a method of cell decomposition to separate a subspace e^{q} comprising products priced at less than 15000 yen, that is, a subspace satisfying the condition for concluding the transaction, from the subspace comprising products otherwise priced. These two subspaces do not overlap but together constitute the entire original space comprising all available products. Further, a “cellular space corresponding to the respective subjects” may be, for instance, denoted cell e^{c} for e-customers and cell e^{s} for e-shops. Presenting products priced at less than 15000 yen to an e-customer is mathematically equivalent to attaching the subspace e^{q} to the cell e^{c}.

Another embodiment of the present invention relates also to an electronic commercial transaction supporting method. This method includes: extracting a correspondence relation between attributes that are objects of interest for a plurality of subjects involved in an electronic commercial transaction from a stage of the electronic commercial transaction; storing the extracted correspondence relation; and presenting the stored correspondence relation at a stage of another electronic commercial transaction.

This embodiment illustrates that a correspondence relation established earlier in time can be reused later. Continuing the example, suppose that an e-customer has just purchased a piece of carpet on the condition that it be “red” and that the e-shop did not give a description of the color of the carpet but simply posted a photograph of the carpet on the Web. Because the transaction has been concluded on the condition that the carpet be red, one could assume that the color of the carpet sold is red. There is then a newly established correspondence relation between two of the carpet's attributes, being “red” and the photograph in the e-shop. When a “red carpet” is requested in any subsequent transactions, the e-shop can present this carpet as a candidate by displaying the photograph. In this way, the history or actual results of past transactions are effectively utilized in future transactions. Broadly speaking, this technology helps to reduce many repetitive activities and operations around the world that waste both human and computing resources.

To illustrate further, now assume that a piece of blue carpet was actually purchased instead of a red one. The correspondence established based on the history of purchase, that of the carpet “being red”, is therefore false. However, this error can be corrected by maintaining and updating the correspondence relation with correspondence information obtained from other transactions. As accumulated corresponding relations increase, more reusable information becomes available for each transaction. With the closing of each transaction, an incrementally more accurate set of correspondence relations is recorded. Furthermore, according to embodiments of the present invention, the process for storing the correspondence relations and the process for showing or presenting them may be cyclically repeated in such a way as to effect mutual feedback.

Another embodiment of the present invention relates to an electronic commercial transaction supporting system. This system includes: a plurality of shops which are connected to a network and present merchandise to customers via the network, wherein each shop of said plurality shops includes a data table which records correspondence relations between attributes that are objects of interest for a plurality of respective subjects in an electronic commercial transaction at a stage of the transaction; and a business information management system (hereinafter “BIM”) connected to the network, which includes a first functional block that refers to respective data tables of said plurality of shops. In this embodiment, the BIM reuses the attribute correspondence relations established in conducted transactions at any shop, including shops other than the one at which the correspondence relation was established. In this way, local activities on the Web can be effectively linked.

The business information management system may further includes a second functional block which detects a desired correspondence relation from the correspondence relations recorded in the data table of any shop and a third functional block which presents the detected desired correspondence relation at a stage of an electronic commercial transaction.

Furthermore, a shop may include a local business information management block, which manages the data table. The local information management block may include a maintaining functional block which inspects correspondence relations and properly modifies the correspondence relations. In particular, the maintaining functional block may detect inconsistencies in the correspondence relations, and, upon finding an inconsistency delete the inconsistent correspondence relation from the data table.

Another embodiment of the present invention relates to a business information management system. This business information management system includes: a first functional block which generalizes a join operation in a relational model, by a form of identification based on an equivalence class, and records correspondence relations between attributes that are objects of interest for a plurality of subjects involved in a business, by the identification in a local circumstance where the business is carried out; a second functional block which reads out a desired correspondence relation from the recorded correspondence relations and reuses the desired correspondence relation at a stage of another business; and a third functional block which maintains or updates the recorded correspondence relations based on a result of the business. In this embodiment, a locally established attribute correspondence relation is made available globally, without assuming the existence of a central management entity that uniformly controls all the attributes or interdependence relations of data. In this embodiment, the form of identification in the first functional block may include a common subspace, extracted by a cellular decomposition operation, in which cells representing respective attributes intersect each other. Further, in the second functional block, a cell corresponding to the common subspace may be attached to the cells corresponding to the respective attributes by a cell attaching operation.

It will be understood that any arbitrary combination of the above-described structural components, elements and expressions, whether applied as or substituted between a method, an apparatus, a system, a recording medium, a computer program and so forth, is still effective as and encompassed by the embodiments of the present invention. Moreover, the features described in this summary are not necessarily all essential features of the present invention.

### BRIEF DESCRIPTION OF THE DRAWINGS

FIG. 1 shows a structure of an electronic commercial transaction supporting system according to an embodiment of the present invention;

FIG. 2 illustrates a correlation among cellular spaces for a plurality of subjects involved in an electronic commercial transaction as well as a subspace that is the intersection of them;

FIG. 3 shows a feedback cycle in which highly reusable information is accumulated according to the cellular information theory and an embodiment of the present invention;

FIG. 4 shows a display of example search conditions entered by an e-customer during a search for desired merchandise;

FIG. 5 shows a display of example search result that an e-mall presents based on the search conditions input by the e-customer in FIG. 4;

FIG. 6 shows an internal structure of a local business information management system.

FIG. 7 shows an internal structure of a global business information management system.

### DETAILED DESCRIPTION OF THE INVENTION

The following description is not intended to limit the scope of the present invention but to describe the invention using preferred embodiments as examples. Not all of the features in the embodiments and the combinations thereof are necessarily essential to the invention.

The following description includes, first, a basic technology section, which presents fundamental concepts for a proposed Cellular Information Model (“CIM”) and, secondly, a section describing preferred embodiments which make use of the CIM.

[Basic Technology]

This section presents a novel information model, called “Cellular Information Model” (“CIM”), that serves to globally integrate local models. As an information model, it is applicable to the category of irregular or random data models that capture spatio-temporal aspects as situations. Mathematically, the CIM is based on cellular spatial structures in a homotopy theoretical framework and is an extension of graph theory.

[1] Modeling of Cyberworlds

Generally speaking, the CIM is based on invariants. Considering a cyberworld as a type of space that includes time as an irreversible element, the cyberworld can be represented by an appropriate choice of invariant or invariants. In particular, an invariant consists of “dimensions”, representing degrees of freedom, and their “connectivity” representing how different dimensional spaces are connected.

Generally speaking, the approach taken to model cyberworlds consists of the following four steps which are first discussed generally and then some are described in more detail below.

First, cyberworlds are characterized to identify the differences from and commonality with the real or actual world. The most distinct difference is in the speed of growth, and hence, in the complexity. In particular, the ability to link “local” worlds into “global” worlds through the Web approaches the speed of light travelling through fiber optic cables. The high speeds realized on the Web provide human beings with tools and power far beyond any in human history.

In essence, everybody working on the Web is a constructor and destructor of cyberworlds.

Second, an appropriate modeling methods to characterize the differences and commonalities are established. In the light of the extreme complexity and the speed of changes, modeling methods based on hierarchical concepts may help to minimize the modeling scale. Moreover, in order to specify any universal characteristics among the constantly changing cyberworlds, a hierarchy should make use of invariants but also provide a format in which concepts can be added later in a modular form. Thus, a model may make use of an incrementally modular abstraction hierarchy of invariants.

Third, the thus constructed methodology for the modeling needs to be implemented as an actual design. In general, the design requires appropriate selection of invariants and formation of specific information structures and operations. For example, a conceptual hierarchy of invariants is designed such that each level in the hierarchy inherits the invariants. Two important invariants, that is, dimension, representing degree of freedom, and connectivity, representing connection between dimensions have been recognized. Further, an information structure called a cellular space may be defined with operations such as cell composition and cell decomposition operating thereon.

Fourth, the thus obtained design is implemented as an information model named as the cellular information model. The cellular information model strengthens the capabilities of existing data models and also maintains cell boundaries, cell dimensionality and cell connectivities. The cellular information model represents cyberworlds in a consistent form which helps to prove legitimacy and can lead to better understanding.

[2] Conceptual Hierarchy of Invariants

Modeling is a very important step in carrying out any scientific research. Particularly in the natural sciences, theories are often constructed around the concept of invariants as a central theme, in order to model the real world. In particular, both objects and phenomena may be classified and modeled based on invariants. For example, in physics, energy and mass were both considered invariant until the theory of relativity was announced. In mathematics, invariants are also used to model objects. Namely, using equivalence relationships (for example, invariants between two objects), mathematical objects are classified into equivalence classes which can be represented by a disjoint union (exclusive OR) of subsets of the objects. Examples of the conceptual hierarchy for the equivalence relation are as follows:

1. Equivalence relations based on set theory.

2. Extended equivalence relations, with homotopy equivalence relations as a special case.

3. Topological equivalence relations, with graph theory equivalence relations as a special case.

4. Equivalence relations based on cellular space structure.

5. Equivalence relations based on information model.

6. Equivalence relations based on presentation or view.

A conceptual hierarchy based on the heirarchy of equivalence relations in mathematics is used-in the cellular information model. This arrangement provides a modular design in which incremental addition is possible. In particular, an inherited hierarchy of invariants for cyberworlds may use the following structure:

1. Set level

2. Extension level; with a homotopy level as a special case.

3. Topological level; with a graph theory level as a special case.

4. Cellular structure space level.

5. Information model level.

6. Presentation level.

[3] Cellular Model

In order to model cyberworlds, a modeling approach based on cellular space structure, such as mathematical CW-spaces, is more versatile than a medeling approach based on graph theory. This versatility comes, at least in part, because, at the cellular structure space level, an object can be specified as a cell in a recognizable and computable space in which there is or is not a boundary. A cell having a boundary is “closed” while a cell without a boundary is “open”. An n-dimensional cell, that is, an “n-cell,” is a space homeomorphic to an n-dimensional ball (n being an integer). Here, an open n-cell is expressed by eⁿ, and a closed n-cell is expressed by Bⁿ. Moreover, the interior of a closed n-cell is denoted by IntBⁿ=Bⁿ Thus, ∂Bⁿ =Bⁿ−Bⁿ=Sⁿ⁻¹ is a boundary of the closed n-cell, and can be considered an (n−1) dimensional sphere Sⁿ⁻¹.

According to cellular modeling, cell composition (or cellular composition, cell attachment, cellular attachment, cell activity, or the like) and cell decomposition (or cellular decomposition, or the like) can be realized while keeping both the dimension and connectivity of the cells as invariant. Thus, identification of an object can be carried out systematically through an identification mapping (also called a quotient mapping). Further, as will be described later, composition and decomposition of a database schema are equivalent to special cases of cell composition and cell decomposition.

Since dimension and connectivity are invarients of the cellular model, it is useful to describe some examples. In a cyberworld, an object may have a particular attribute and cannot move from one attribute to another attribute, such that its degree of freedom is 0. Thus, its dimension is also zero. In this case, in the presentation level, this can be expressed by a “point”. Here, an attribute is a mutually independent set for identifying a characteristic and distinctive feature that the object owns intrinsically. For an object having two attributes, transition from one attribute to another is possible, so that its degree of freedom and its dimension are “1”. Therefore, in the presentation level this can be expressed by a straight line. In a similar manner, objects with three and four attributes correspond to two dimensions and three dimensions, respectively, and can be expressed by a curved surface and a ball, respectively. In general, an object having n attributes has (n−1) degrees of freedom and its dimension is n−1. This can be expressed as an (n−1)-dimensional sphere. In contrast, in a relational model, an object having n attributes is expressed as a relational schema, and is represented as an n-column table. The relational model is based on the direct product of sets and therefore can be said to be an expression at a set-theoretic level.

Note that an object with n attributes is represented with a (n−1)-dimensional cell. In this case, the nth attribute may be used for indexing the object in an object table or object database or the like. Alternately, apart from the nth attribute, a new dimension may be added for indexing purposes.

Connectivity is also invariant and is defined by an attaching map (also called an adjoining map, adjunction map, joining map, gluing map, or the like), which is a continuous and surjective mapping. A mapping f: X→Y is surjective if

(∀y∈Y)(∃χ∈X)[ƒ(χ)=y]

A mapping f: X→Y is continuous if a subset A of Y is open in Y if and only if {f⁻¹(y)|y∈A} is open in X.

Given disjoint topological spaces X and Y (that is, where X and Y have no intersection therebetween),

Y∪_{f}X=Y∪X/˜

is an attaching space obtained by attaching X to Y by an attaching map f: Xₒ→Y. Here, ∪ denotes the exclusive OR (which may also be denoted by a plus sign (+) and ˜ indicates an equivalence relation. An equivalence relation is a relation that satisfies the reflexive law “x˜x”, the symmetric law “if x˜y, then y˜x”, and the transitive law “if x˜y and y˜z, then x˜z”. Examples of equivalence relations include set-theoretic equivalence relations, homotopy equivalence relations, topology equivalence relations and so forth. The transitive law partitions a space into disjoint subsets called equivalence classes.

Since equivalence relations and equivalence classes are important to the cellular model, these concepts are now described in more detail. A subset of X defined by x/˜={y∪X:x˜y} is called an equivalence class of x. Here, even though the “class” is actually a set, it is conventionally referred to in this way. A set X/˜ including all the equivalence classes is called a quotient space (or identification space) of X, and is expressed by

X/˜={x/˜∈2^{x}|x ∈X}⊂2^{x}

From the transitive law, the following equations hold for x which satisfies x∈X, and for x which satisfies x/˜≠Ø.

x˜y⇄x/˜=y/˜, and

x [symbol] y⇄x/˜∩y/˜=Ø.

This means that the set X is partitioned (or decomposed) into nonempty disjoint equivalence classes. Here, the equivalence class is expressed by x/˜ which means

x/˜˜{y∈X|x˜y}.

Let us explain the above using some simple examples. “Cardinality” is an equivalence relation in set theory in which an original set is partitioned into disjoint subsets having the same cardinality. “Isomorphism” is an equivalence relation in graph theory in which a set of graphs can be partitioned into subsets of disjoint isomorphic graphs. Further, in Euclidean geometry, “congruence” also forms an equivalence relation in which figures can be partitioned into subsets consisting of mutually congruent figures. “Similarity” is also an equivalence relation in which figures can be partitioned into subsets consisting of similar figures. Congruence and similarity are examples of affine transformations. “Symmetry” is another example of an equivalence relation in group theory and a set can be partitioned into mutually disjoint subsets consisting of symmetric figures. In these examples, the subsets do not have intersections and their union coincides with the original set. This union Corresponds to the quotient space.

Returning now to the general definition of the attaching map, a set of all equivalence classes is denoted by X/˜ and is expressed by the following equation:

X/˜={x/˜∈2^{x}|x∈X}⊂2^{x}.

As described above, this is also called the quotient space of X. An attaching map f is a surjective (onto) and continuous mapping:

f:XₒY(Xₒ⊂Y)

where X∪Y/˜ is a quotient space and has the following relation:

X∪Y/˜=X∪Y/(x˜f(x)|∀x∈Xₒ)=X∪_{f}Y

Here, as will be described later, we consider special cases for the integration of data schema and data integration in data mining on the Web. Now, Sⁿ⁻¹ is the boundary of a closed n-cell, and can be expressed by

Sⁿ⁻¹=∂Bⁿ=Bⁿ−IntBⁿ=Bⁿ−eⁿ

Here, an attaching map f which is surjective and continuous is defined by

f:Sⁿ⁻¹→X

Then, an additional (or adjunction) space Y is defined as a quotient space as follows

Y=X∪_{f}Bⁿ=X∪Bⁿ/{f(u)˜u|u∈Sⁿ⁻¹}

Now, consider homotopic mappings f and g

f, g:Sⁿ⁻¹→X.

Then, there is generated a homotopy equivalence relation such that

X∪_{f}Bⁿ≅X∪_{g}Bⁿ

Given an arbitrary cyberworld X as a topological space, it is possible to compose (according to recursive induction concepts proposed by J. H. C. whitehead) a finite or infinite sequence of cells, X^{p}, that are subspaces of X in which the index P is given by integers Z. Namely, a filtration {X^{p}|X^{p} ⊂X, p∈Z} can be formed. Here, X^{p} is called a covering of X and the following relation holds:

$$X = {⋃}_{p ∈ Z} {X}^{p}$$

Moreover, X^{p-1} is a subspace of X^{p}, namely,

X⁰⊂X¹⊂X²⊂ . . . ⊂X^{p-1}⊂X^{p}⊂ . . . ⊂X.

This arrangement may also be called a skeleton and a skeleton whose maximum dimension is p is called a p-skeleton. Each of X⁰, X¹, X², . . . , X^{p-1} and X^{p} are partial cyberworlds or sub-cyberworlds of the cyberworld X. A space which is topologically equivalent to the filtration is called a filtration space.

For practical application, there are two important cellular space types: CW-complexes and manifolds. When a filtration space is finite, it is equivalent to a CW-complex (or “CW-space”). Moreover, when a CW-space has differentiability, it is equivalent to a manifold (or “manifold space”).

[4] Web Information Modeling, Inductive Web-Information Schema Integration, and Web-Information Integration via Information Mining Based on a Cellular Model

As a first step to model Web information, the formation of a cyberworld can be characterized in order to discern how the cyberworld emerged and what its substance is. A cyberworld X is oftentimes formed on the Web as a result of various local activities in many Web sites. Unlike corporate information, there is generally no information manager or database administrator to give an initial set of schemas. However, through processes of information mining or data mining, one can develop a cyberworld X by recovering particular information from a plurality of local Web sites. Of course, the data mining should not be carried out randomly. By initially browsing a plurality of Web sites it is possible to develop ideas as to what information occurs at a plurality of Web sites as well as what combinations thereof or what other information is predicted to appear. This type of data mining is generally called “data mining based on a design”, because there are predetermined rules to apply as “integration guidelines” concerning the subjects to be mined. This integration guideline works as a design guideline for what and how to integrate mined information.

By data mining on the Web according to the above-described Whitehead recursive scheme, it is possible to integrate local cyberworlds on the Web into larger, and possibly global, cyberworlds.

An example method by which an n-dimensional cyberworld Xⁿ can be acquired by data mining on the Web and processes of integration will now be described.

Recursive integration is comprised of two phases, first, an information schema integration phase and, second, an information integration phase. The information schema integration phase proceeds as follows:

1. Retrieve attributes B⁰ᵢ which are attributes that are a subject of interest at a Web site to form the following cyberworld X⁰ of 0 dimension.

X⁰={e⁰₁, e⁰_{2, e}⁰₃, e⁰ⱼ}

2. Retrieve attributes B¹ᵢ which are all combinations of two attributes that are the subject of interest at the Web site in order to generate a one-dimensional cyberworld X¹. The disjoint union of these attributes

∪ᵢB₁ᵢ=B¹₁∪B¹₂∪B¹₃ . . . ∪B¹ₖ

is attached to X⁰ by an attaching map F. In this manner, a one dimensional cyberworld X¹ can be obtained:

X¹=X⁰∪_{F} (∪ᵢB¹ᵢ)=X⁰∪(∪ᵢe¹ᵢ),

where i=1, 2, . . . , k, and the attaching map F is

F:∪ᵢ∂B¹ᵢ→X⁰.

3. Now after repeating the above steps, an (n−1) dimensional cyberworld Xⁿ⁻¹ has been formed through data mining. Here, Xⁿ⁻¹ has n attributes. In order to generate an n-dimensional cyberworld Xⁿ which has (n+1) attributes, all combinations of (n+1) attributes Bⁿᵢ which are the subjects of interest in the Web site are retrieved in a similar manner to the above. Next, the disjoint union

∪ᵢBⁿᵢ=Bⁿ₁∪Bⁿ₂∪Bⁿ_{3∪}∪ . . . ∪Bⁿₖ

is attached to the already composed (n−1) dimensional cyberworld Xⁿ⁻¹ through an attaching map G. As a result thereof, the following n-dimensional cyberworld Xⁿ can be generated:

Xⁿ=Xⁿ⁻¹∪_{G}(∪ᵢBⁿᵢ)=Xn−1∪(∪ᵢeⁿᵢ)

where i=1, 2, . . . , k, and the attaching map G is

G:∪ᵢ∂Bⁿᵢ→Xⁿ⁻¹.

The above processes complete the integration of the information schema.

The second phase, the information integration phase, is fairly simple but computationally intensive. In this phase, every instance which is to be included in the cyberworld is checked, based on the design guideline, in every step of the cell attachment to determine if the instance should be included in the cyberworld being created in the schema integration.

A cyberworld constructed based on the above Whitehead recursive methodology satisfies the following relation:

X⁰⊂X¹⊂X² ⊂ . . . ⊂Xⁿ⁻¹⊂ . . . ⊂X

From the standpoint of the effectiveness of the cyberworld, the above relation means that, given a valid cyberworld, it will contain valid cyberworlds of lower dimension.

In the above examples, identification is carried out by equivalence class based on equivalence relations. The “identification by equivalence class” is a generalization of a join operation in the relational model. This point shows one of the practical benefits of the cellular model. In light of the highly complex and extremely fast changes in cyberworlds on the Web, this integration capacity of the cellular model provides a truly theoretic foundation for a Web information model.

In the above, in the statement “an attribute which is the subject of interest”, the “interest” means, at least partially, a choice of equivalence relation for identification. In other words, the choice of the equivalence relation for identification is a major part of the design guideline. In information systems relating to the Web, a design guideline may exist locally in order to integrate local sites as an intranet or community net, or may exist globally in order to operate in borderless cyberworlds. Design guidelines can be reusable resources for Web-based information systems.

[5] Situation Modeling of Web Information as Non-Recursive Information Schema Integration and Information Integration Based on the Cellular Model

On the Web, there often arises a need for creating a new cyberworld from arbitrary cyberworlds. This is more general than data mining through the recursive method described above, and is often a requirement in e-business, including electronic commercial transactions on the Web. For example, consider electronic commercial transactions as a Web situation that varies in both aspects of time and space. In order to construct an information model of electronic commercial transactions, it is necessary to generally determine a structure of a commercial transaction on the Web from a standpoint of the information schema. Typical situations in electronic commercial transactions include the following:

Situation 1.

An e-customer who desires to purchase certain merchandise browses a Web to search for an e-shop which sells the merchandise at the lowest price.

Situation 2.

An e-shop which sells merchandise browses a list of potential e-customers to expand sales of its merchandise.

In these situations, we are not necessarily interested in finding out all detailed information regarding the e-shop, e-customer and e-merchandise on the Web we are only interest in sub-set of information. Here, let the e-shop, e-customer and e-merchandise be cyberworlds of s, c and m dimensions, respectively, and let them be denoted by s-cell e^{s}, c-cell e^{c} and m-cell e^{m}, respectively.

In situation 1, when desired e-merchandise is offered at a certain e-shop at the lowest price, the e-customer is interested as a purchaser and specifies or identifies the name of the merchandise at that e-shop. This situation can be characterized by a cellular decomposition operation and an identification operation performed after the cellular decomposition operation. The cellular decomposition operation is expressed by a mapping f that maps a given n-dimensional cell eⁿ to a union of two disjoint cells such that the attaching map g is preserved:

e^{u}∪_{g}e^{v(u, v≦n)}

f:Bⁿ→Bⁿ∪_{g}B^{v}=eⁿ→e^{u}∪e^{v}

As will be described later, by preserving the attaching map in each cellular decomposition the cellular decomposition can be made homotopic. Situation 1 can be understand by the following steps, representing a “situation model”.

1. Cell Decomposition

The s-cell e^{s} as an e-shop, the c-cell e^{c} as an e-customer and the m-cell e^{m} as an e-merchandise are decomposed and an equivalent cell e^{q} is separated in order to specify attributes relating to the electronic commercial transaction. In particular case, e^{q} may be e² wen the attributes are, for example, merchandise name, merchandise identifying information, and merchandise price.

2. Cell Composition by Cell Attachment

The equivalence cell e^{q} is identified by the attaching map. In other words, the m-cell e^{m} as the e-merchandise and the s-cell e^{s} as the e-shop are attached to the c-cell e^{c} as the e-customer.

In a similar manner, situation 2 may also be understood by the following situation model.

1. Cell Decomposition

It is similar to the situation 1.

2. Cell Composition by Cell Attachment

The equivalence cell e^{s} is identified through the attaching map. In other words, m-cells {e^{m}ᵢ} as the e-merchandise and c-cells {e^{c}ᵢ} as e-customers are attached to the s-cell e^{s} as the e-shop.

[6] Homotopy as a Theoretic Framework of the Cellular Model for Space/Time Information and Space/Time Operation

In an information society, the development of web-related theories and cyber-world-related science is expected to play a large role in the development of information technology based on the Web. The cellular information model and cellular space make use of mathematical frameworks as described above and also including homotopy theory as described hereafter.

The homotopy theory serves as a foundation of cellular space structure in that we rely on it to represent changes of a cyberworld in time and space. Homotopy theory is utilized to accommodate space/time information and space/time operations. Now, for example, consider a change of a mapping function f relating a topological space X to another topological space Y. After the change, f becomes another mapping function g. Therefore, we are considering a continuous deformation of f to g wherein.

f,g:X→Y

Let us consider this deformation in a normalized interval [0, 1]. This interval may be of time, space or otherwise. Now, let A (A⊂X) be a subspace, of the topological space X, that does not change. A homotopy H to be designed is as follows.

H:X×I→Y

where (∀χ∈X) (H(χ, 0)=ƒ(χ) and H(χ, 1)=g(χ)) and

(∀α∈A, ∀t ∈I) (H(α, t)=ƒ(α)=g(α)).

Then, f is called homotopic to g with respect to A, and expressed as follows:

f≅g (rel A)

Here, a new problem arises in terms of the design. Namely, the issue is how to design two topological spaces X and Y that have homotopy equivalence X≅Y, in other words, a method by which these spaces can be designed to have the same homotopy type. This problem can be solved by considering that, it suffices that f:X→Y and h:Y→X satisfy the following conditions.

h∘ƒ≅1ₓ and ƒ∘h≅1_{y},

where 1ₓ and 1_{y} are identity mappings, and satisfy the following.

1ₓ:X→X and 1_{y}:Y→Y

By implementing the above-described method, the dimension of a cell can be changed homotopically. Homotopy equivalence is a broader concept than topology equivalence. In homotopy equivalence, any change of the cyberworld, even if no longer topologically equivalent after the change, can be identified. When a cyberworld goes through transitions by various operations and processings, the process of the transitions is specified by a homotopy and validated by homotopy equivalence. For example, when executing each cell decomposition, the attaching map is preserved because this allows the cell decomposition to be preserved homotopically and thus the process of cell decomposition can be traced in the reverse direction.

[Preferred Embodiments]

We now describe an electronic commercial transaction supporting system and method and a business information management system according to an embodiment of the present invention. The business information management system is based on the basic technology described above and is applied to an electronic commerce supporting system and method for presenting and selling merchandise on the Internet.

In the following embodiment, we consider two e-malls, each consisting of a plurality of e-shops and both sharing between them attribute correspondence data through a global business information management system (BIM). E-malls instead of individual e-shops are used here because it is easier and more efficient for an e-customer to search for a particular item in multiple e-shops all at once than to do so in each individual shop one by one. The BIM according to the present invention presumes that the subjects of a transaction possess certain information and that such information is manageable to a certain degree at least locally, though not necessarily globally.

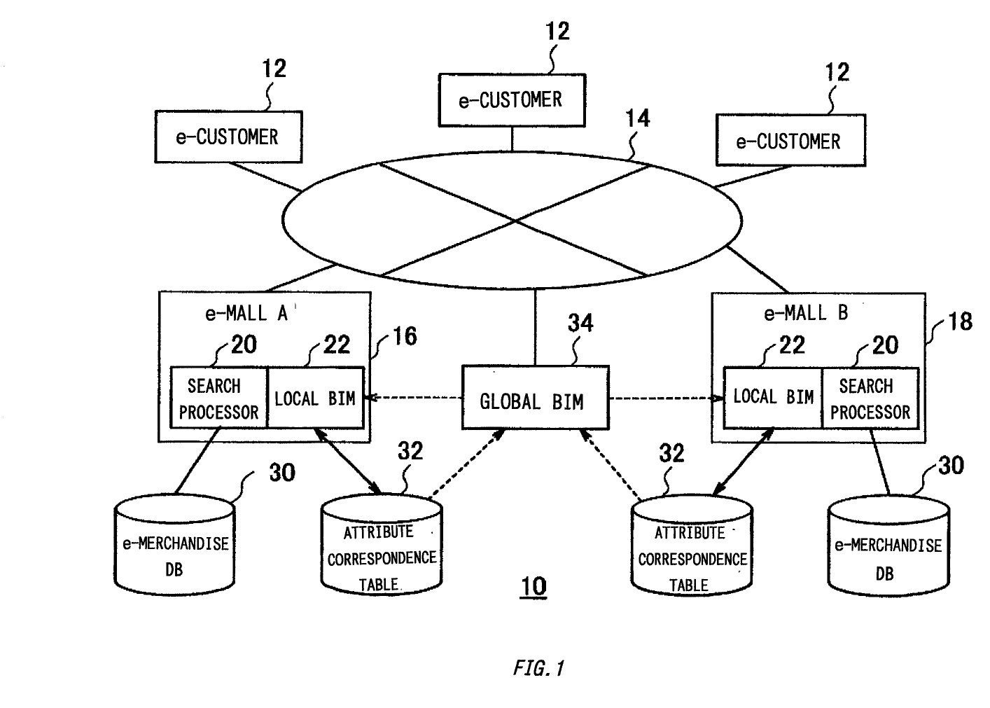

Referring to FIG. 1, a network 14, such as the Internet, connects a plurality of e-customers 12 and two e-malls, e-mall A 16 and e-mall B 18, each respectively comprising a plurality of e-shops. Each of the two e-malls respectively includes the following: an e-merchandise database 30, which stores merchandise information of the e-shops opened in the respective e-mall; an attribute correspondence table 32, which describes correspondence relations of attributes of interest gathered at the conclusion of the transactions between e-customers 12 and the respective e-mall; a search processor 20, which searches desired merchandise information in the e-merchandise database 30; and a local BIM 22, which records in the attribute correspondence table 32 the correspondence relations among the attributes based on transaction history or result, and maintains the same when required.

A global BIM 34 instructs, when appropriate, the e-mall A 16 and the e-mall B 18 and controls the format of correspondence relation data in the attribute correspondence tables 32. The global BIM 34 may cross-reference all the attribute correspondence tables 32 and may present a correspondence relation established in one e-mall, say the e-mall A 16, to an actual site of transaction in the other e-mall, the e-mall B 18. The global BIM 34 could be a third party, which undertakes to provide support systems for electronic commercial transactions for a plurality of e-malls. The global BIM 34 dictates the designs and structures of the local BIM's 22 and the attribute correspondence tables 32 in both the e-mall A 16 and the e-mall B 18.

A plurality of e-malls may agree to exchange information among them to facilitate speedy transaction. Once such an affiliation between two e-malls is established, the ensuing sharing of the attribute correspondence relations causes the system efficiency to drastically and continuously increase. This increase in efficiency is partly the result of modular characterization, as it is referred to in the basic technology, and partly due to the structure in which necessary information can be properly accumulated on a continuing basis. Because of this potential of increased efficiency, e-malls that have no affiliation with the electronic commercial transaction supporting system 10 at the outset are likely to do so in the future.

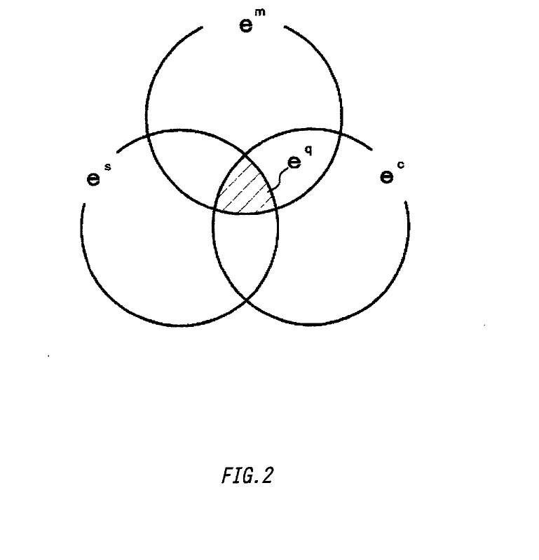

FIG. 2 illustrates the correlation among the cell e^{m} (e-merchandise), the cell e^{c} (e-customer) and the cell e^{s} (e-shop or e-mall as in the present example). The cell e^{s} which is the intersection of cells e^{m}, e^{s} and e^{c}, represents a common subspace in which a transaction is capable of being concluded.

The cell e^{s} represents the attributes of the merchandises offered by the e-mall and the attributes of the e-mall itself.

The cell e^{c} represents the attributes of the merchandise the e-customer desires and the attributes of the e-customer him/herself.

The cell e^{m} represents the attributes of the merchandise. In many situations, the merchandise information is provided by the e-mall. However, the cell e^{m} may also contain information the e-mall does not necessarily possess, such as information provided by the manufacturer of the merchandise.

An electronic commercial transaction can be generally modeled by superimposing the three cells.

From the perspective of concluding a transaction, a common area of the cell e^{s} and the cell e^{c} represents a subspace in which the supply and the demand match, in terms of the attributes that each respective cell, as a subject of the transaction, is interested in.

The common area of all three cells, the cell e^{q}, represents the merchandise that satisfy the conditions specified by both the e-mall and the e-customer, such as a condition that the merchandise is “less than 15000 yen”. Using a general expression from the basic technology, the cell e^{q} , which enables a transaction to conclude, corresponds to an equivalence cell e^{q} that is separated as a subspace that satisfies the predetermined equivalence relation, the price of the merchandise. As such, a cellular decomposition operation can be used to extract this subspace.

In the basic technology, an object having n attributes is defined to be an (n−1) dimensional sphere. In a pure mathematical sense, an object having n attributes can be said to be an n dimensional sphere. However, when the cellular information model is applied in actual construction of a database, each attribute has to have an index and the index becomes an additional attribute. Therefore, in reality, an object in the basic technology has only (n−1) true attributes and is hence (n−1) dimensional.

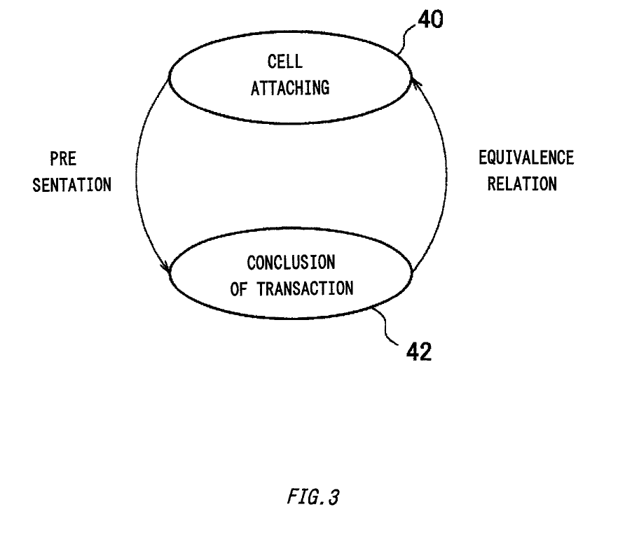

FIG. 3 shows a complete cycle in which the attribute correspondence relation is processed in the electronic commercial transaction supporting system 10. In a cell attaching operation 40, where the cell e^{q}, a subspace to conclude a transaction, is attached to the cell e^{c} or the cell e^{s}, both being the subjects of the transaction, a desired merchandise is presented to the e-customer in a certain form while the e-customer's specific request is presented to the e-mall. The Conclusion of transaction operation 42 occurs after this presentation process. A new correspondence relation, which did not exist prior to this transaction, is established by inspecting the transaction history. This correspondence relation is derived, under the equivalence relation, from the keywords used by the e-customer for searching the desired merchandise and the information provided by the e-mall as a result of the search. According to the present embodiment, a new cell attaching operation 40 may begin after the conclusion of transaction operation 42 and the correspondence relation established in the new process can be presented in a future transaction. The information necessary for concluding a transaction is then successively accumulated as the cell attaching operation 40 and the conclusion transaction operation loop in a never-ending cycle.

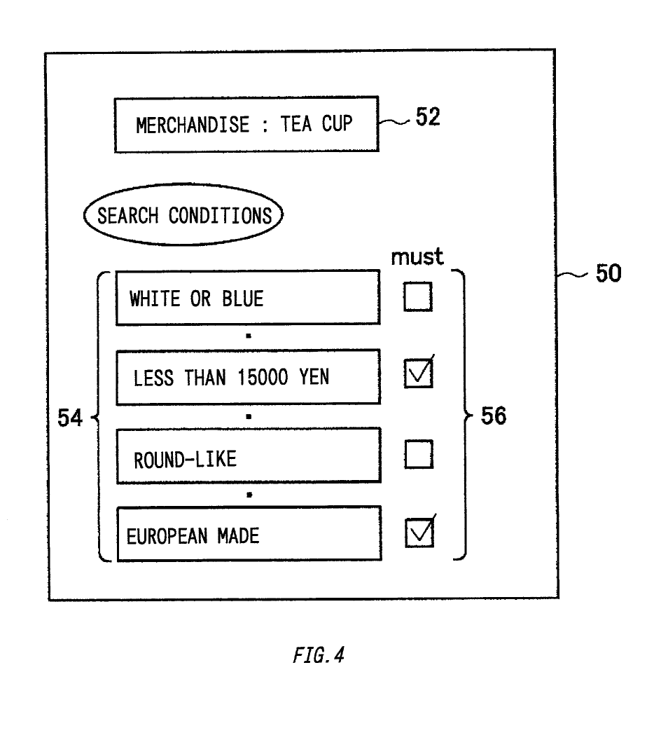

FIG. 4 shows an example display screen 50 through which the e-customer may search for desired merchandise. In this example, the merchandise 52 searched is a “tea cup”. In this example, plurality of search conditions 54, such as “white or blue”, “less than 15000 yen”, “round-like”, and “European made”, may be entered in free format. Required conditions may be marked as “must” in column 56. In this example, the e-customer marked “less than 15000 yen” and “European made” as indispensable conditions, while “white or blue” for color and “round-like” for overall shape are entered as desired but not required conditions. These search conditions are fed to a search processor 20 of the e-mall A 16, which then extracts desired merchandise information from the e-merchandise database 30.

It is noted that a condition, or attribute, specified by the e-customer may not exactly match description or attribute of merchandise provided by the e-mall. In some cases, it may be difficult to interpret a customer request or to assess the correspondence relation between certain attributes without human judgement. For instance, in this example, the e-customer requested the color to be “white or blue” but the e-mall may not have information about the colors of its merchandise and, without human input, it may be difficult to determine if the color of a particular merchandise meets the request.

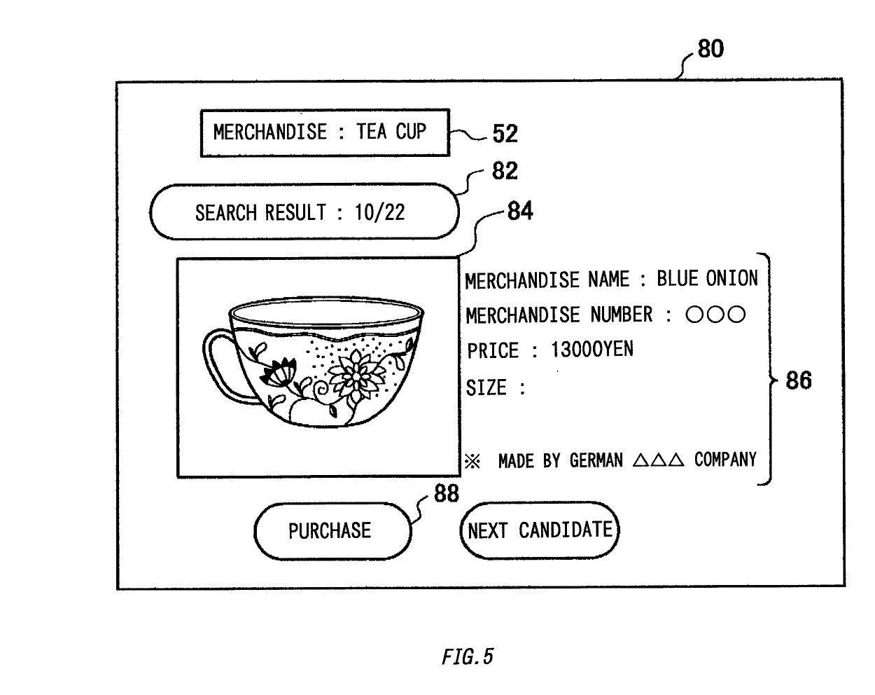

FIG. 5 shows an example display result of the search described above and in FIG. 4. In a search result area 82 the display shows the number of matches (22 here) and the particular result displayed (10 here). A photograph 84 of the merchandise and a merchandise description 86 are also provided. A purchase button 88 is also provided, which can be clicked or pressed if the e-customer decides to purchase this particular merchandise. It is noted that the merchandise presented by the e-mall does not necessarily satisfy all search conditions entered by the e-customer. For example, it is possible that the e-mall only searched for merchandise that satisfied the condition “less than 15000 yen”, for the simple reason that price is an attribute that is easy for a computer or search engine to assess. In certain cases, the search results may contain a large portion of undesirable merchandise.

In the example shown in FIG. 5, the tenth search result, out of the twenty-two results, is displayed. Suppose that the e-customer decides that this particular merchandise matches most closely to what she/he wants and presses the purchase button 88 to make the purchase. This instruction to conclude the transaction may initiate a payment process and is also sent to the search processor 20 and, from there, forwarded to the local BIM 22. A new correspondence relation is therefore established and can be recorded in the attribute correspondence table 32 when appropriate.

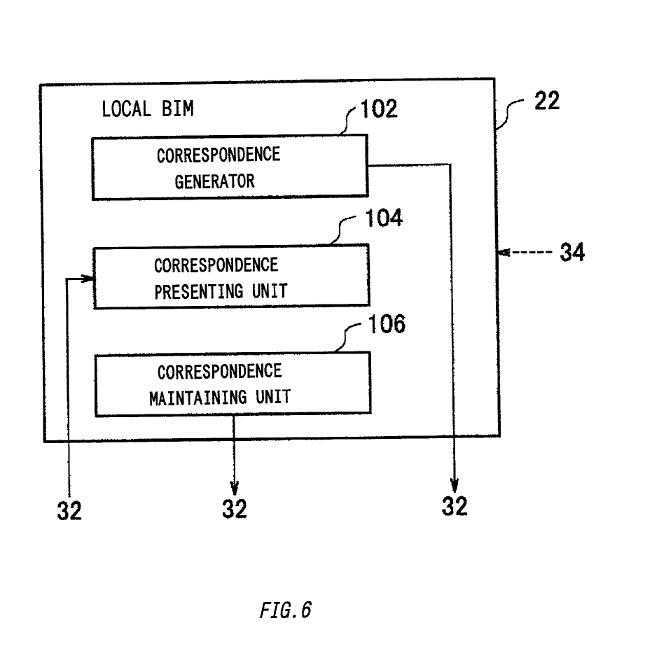

FIG. 6 shows an internal structure of the local BIM 22. The local BIM 22 includes a correspondence generator 102, a correspondence presenting unit 104 and a correspondence maintaining unit 106.

The correspondence generator 102 receives notification from the search processor 20 when a transaction is concluded and then records a new correspondence relation in the attribute correspondence table 32 . If an attribute specified in the transaction did not previously exist in the attribute correspondence table 32, such as “white or blue” or “roundlike” in the present example, it is added to the attribute correspondence table 32 and the correspondence relation between the new attribute and a pre-existing attribute, such as the photograph 84, is recorded in the attribute correspondence table 32. Moreover, a correspondence relation that may be common with a correspondence relation listed in the merchandise description 86, such as “European made” and “Made by German ΔΔΔ Company”, is recorded in the same format.

The correspondence presenting unit 104 supplies necessary information to the search processor 20 in a subsequent transaction, based on the correspondence relation in the attribute correspondence table 32. For example, when another e-customer wishes to purchase a teacup on another occasion and specifies “white” or “blue” as the color, the teacup shown in FIG. 5 can be presented as a candidate.

The correspondence maintaining unit 106 corrects or deletes apparently false entries accumulated in the attribute correspondence table 32. In a particular case, the correspondence maintaining unit 66 may use statistical analysis techniques for this purpose. For example, suppose that an e-customer purchases the teacup shown in FIG. 5, but the e-customer had initially requested a “red” teacup. The color attribute of the teacup is likely deemed to have a correspondence with “red” based on this transaction. However, if there have been one hundred transactions involving this particular type of teacup and in the majority of them, say eighty transaction, the correspondences established are “white or blue”, the correspondence maintaining unit 106 may detect the discrepancy and delete the teacup's correspondence with “red” from the attribute correspondence table 32. In this manner, the integrity and reliability of the attribute correspondence relation table 32 is maintained at an acceptable level and errors in future transactions are minimized.

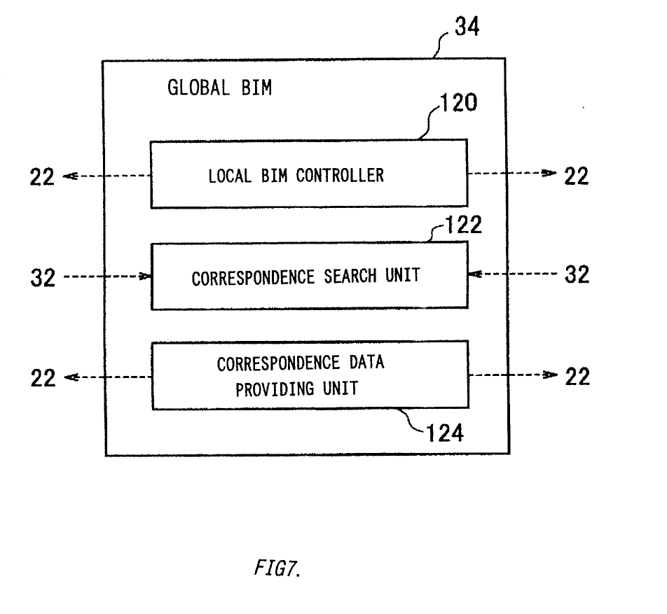

FIG. 7 shows an internal structure of the global BIM 34. The global BIM 34 includes a local BIM controller 120, a correspondence search unit 122 and a correspondence data providing unit 124. The local BIM controller 120 monitors and controls, when required, the operation of respective local BIM's 122 of a plurality of e-malls (in the present example, the e-mall A16 and the e-mall B18). One of the functions of the local BIM controller 120 is to update the local BIMs 22 implemented in the plurality of e-malls. Another function of the local BIM controller 120 is to notify local BIMs 22 when any one of the local BIMs 22 deletes an apparently false correspondence relation from its attribute correspondence table 32, so that consistency among and effectiveness of the attribute correspondence tables 32 in all the e-malls are maintained and enhanced.

In order to be able to extract a particular correspondence relation of interest from the attribute correspondence table 32 of any e-mall, the correspondence search unit 122 monitors the attribute correspondence tables 32 of all e-malls. Once the particular correspondence relation of interest is found in any one of the e-malls, the result is communicated to the correspondence data providing unit 124.

Upon receiving the result from the correspondence search unit 122, the correspondence data providing unit 124 communicates the particular correspondence relation to the local BIM 122 that has requested such relation. The local BIM 122 may or may not enter this correspondence relation into its own attribute correspondence table 32, depending on the circumstances, but will send the correspondence relation to the search processor 20. The correspondence relation can therefore be effectively utilized in both the current and any future transactions conducted in the e-mall. In the present embodiment, the global BIM 34 constantly and efficiently links a plurality of the attribute correspondence tables 32 on a global level. It is not necessary for the local BIM 22 to record every single correspondence relation established in other e-malls in the local attribute correspondence table 32. According to the present embodiment, it suffices that each local BIM 22 records only the correspondence relations established locally in the local attribute correspondence table 32. In a sense, the whole system according to the present embodiments is a self-supported and distributed database management mechanism.

The present invention has been described based on the above embodiments. There are various modifications to these embodiments and different combinations of the elementary techniques described herein. A person skilled in the art would understand that such modifications and combinations are encompassed by the scope of the present invention. Some such modifications are described below.

In the present embodiments, the cellular information theory developed by the inventor of the present invention is applied to the electronic commercial transactions. However, the present invention has a far wider field of application. In any arbitrary business carried on via a network by a plurality of subjects, the present invention is applicable for managing the correspondence relations between attributes of the subjects in the business.

In FIG. 1, the global BIM 34 is an independent unit separate and external to the e-mall A 16 and the e-mall B 18. However, the functions of global BIM 34 may be performed respectively by the e-mall A 16 and the e-mall B 18 and, in that case, the local BIM 22 and the global BIM 34 are integrated in the respective e-malls. As long as the local BIM's can communicate with each other directly and freely across the borders of e-malls, the correspondence relations generated locally in each e-mall can be accessed and shared globally.

It should be understood that many changes and substitutions in the embodiments described herein may be made by those skilled in the art within the spirit and the scope of the present invention which is defined by the appended claims.

What is claimed is:

1. An electronic commercial transaction supporting method, comprising:
extracting, by a cell operation of a technique of cellular information theory, correspondence relations between attributes determined by respective viewpoints of a plurality of subjects involved in an electronic commercial transaction;
recording the extracted correspondence relations; and
presenting the recorded correspondence relations at a stage of an electronic commercial transaction.

2. An electronic commercial transaction supporting method, comprising:
specifying correspondence relations between attributes determined by respective viewpoints of a plurality of subjects involved in an electronic commercial transaction based on a predetermined equivalence relation;
extracting the specified correspondence relation by a cell operation based on cellular information theory;
accumulating extracted correspondence relations in a data table, based on actual examples of an electronic commercial transaction; and
presenting the accumulated correspondence relations as a part of another electronic commercial transaction, by referring to the data table.

3. An electronic commercial transaction supporting method, comprising:
extracting, based on a predetermined equivalence relation, an attribute that is an object of interest common to a plurality of subjects involved in an electronic commercial transaction using a method of cell decomposition in cellular information theory; and
adding the extracted attribute to a cellular space corresponding to each of the plurality of subjects using a cell attachment.

4. An electronic commercial transaction supporting method, comprising:
extracting a correspondence relation between attributes that are objects of interest for a plurality of subjects involved in an electronic commercial transaction, from a stage of the electronic commercial transaction;
storing the extracted correspondence relation; and
presenting the stored correspondence relation at a stage of another electronic commercial transaction.

5. A method according to claim 4, wherein said extracting, storing and said presenting are repeated cyclically in such a way as to effect feedback.

6. An electronic commercial transaction supporting system, comprising:
a plurality of shops which are connected to a network and present merchandise to customers via the network, wherein each shop of said plurality of shops comprises a data table which records correspondence relations between attributes that are objects of interest for a plurality of respective subjects in an electronic commercial transaction at a stage of the transaction; and
a business information management system connected to the network, wherein said business information management system comprises a first functional block which transversely refers to respective data tables of said plurality of shops.

7. A system according to claim 6, wherein said business information management system further comprises a second functional block which detects a desired correspondence relation from the correspondence relations recorded in the data tables of any of said plurality of shops.

8. A system according to claim 7, wherein said business information management system further comprises a third functional block which presents the detected desired correspondence relation at a stage of an electronic commercial transaction at any of said plurality of shops or at another shop.

9. A system according to claim 6, wherein a shop of said plurality of shops further comprises a local business information management block which manages the data table.

10. A system according to claim 7, wherein a shop of said plurality of shops further comprises a local business information management block which manages the data table.

11. A system according to claim 8, wherein a shop of said plurality of shops further comprises a local business information management block which manages the data table.

12. A system according to claim 9, wherein said local business information management block comprises a maintaining functional block which inspects correspondence relations and suitably modifies the correspondence relations.

13. A system according to claim 10, wherein said local business information management block includes a maintaining functional block which inspects correspondence relations and suitably modifies the correspondence relations.

14. A system according to claim 11, wherein said local business information management block includes a maintaining functional block which inspects correspondence relations and suitably modifies the correspondence relations.

15. A system according to claim 12, wherein said maintaining functional block detects an inconsistent correspondence relation among the recorded correspondence relations and deletes said inconsistent correspondence relation from the data table.

16. A system according to claim 13, wherein said maintaining functional block detects an inconsistent correspondence relation among the recorded correspondence relations and deletes said inconsistent correspondence relation from the data table.

17. A system according to claim 14, wherein said maintaining functional block detects an inconsistent correspondence relation among the recorded correspondence relations and deletes said inconsistent correspondence relation from the data table.

18. A business information management system based on cellular information theory, comprising:
a first functional block which:
generalizes a join operation in a relational model by an identification based on an equivalence class; and
records correspondence relations between attributes that are objects of interest for a plurality of subjects involved in a business, by the identification in a local circumstance where the business is carried out;
a second functional block which reads out a desired correspondence relation from the recorded correspondence relations and reuses the desired correspondence relation at a stage of another business; and
a third functional block which maintains or updates the recorded correspondence relations based on a result of the business,
wherein a correspondence relation between attributes formed locally is made available globally by said functional blocks using a modeling guideline that does not assume the existence of a management entity who uniformly manages all the attributes or interdependence relations of data.

19. A business information management system according to claim 18, wherein the identification in said first functional block comprises a common subspace of cells corresponding to the respective attributes interest to one another, the common subspace being extracted by a cell decomposition operation.

20. A business information management system according to claim 19, wherein, in said second functional block, a cell corresponding to the common subspace is attached to the cells corresponding to the respective attributes by a cell attaching operation.
